(19) United States
(12) Patent Application Publication
(10) Pub. No.: US 2008/0141798 A1
(43) Pub. Date: Jun. 19, 2008

(54) STORED ENERGY TRIGGER DESIGN

(75) Inventor: Gary R. Thomas, Livonia, MI (US)

Correspondence Address: ARTZ & ARTZ, P.C., 28333 TELEGRAPH ROAD, SUITE 250, SOUTHFIELD, MI, 48034, US

(73) Assignee: Lear Corporation, Southfield, MI (US)

(21) Appl. No.: 11/551,419

(22) Filed: Oct. 20, 2006

(51) Int. Cl. F16H 33/00

(52) U.S. Cl. 74/2

(57) ABSTRACT

A stored energy trigger assembly is provided including a mounting substrate and a pawl plate rotationally mounted thereto having a pawl mount end, a pawl trigger end, and a pawl lock protrusion positioned between. The pawl plate rotatable between a pawl lock position and a pawl disengage position to which it is biased. A cam plate is rotationally engaged to the mounting substrate and includes a cam plate upper surface, a cam plate lower surface, a cam lock slot, and a push wire engagement protrusion positioned on a cam plate periphery. It is rotatable between a cam lock position and a cam release position to which it is biased. A pawl trigger element engages the pawl trigger end and is configured to move the pawl plate to the pawl disengage position. A push wire assembly is moved a wire activation distance when the cam plate is moved to the cam release position. The pawl lock protrusion is positioned within the cam lock slot and restrains the cam plate until the pawl trigger element moves the pawl plate into the pawl disengage position wherein the pawl lock protrusion moves out of the cam lock slot and the cam plate is free to move into the cam release position.

### TECHNICAL FIELD

The present invention relates generally to a stored energy trigger design and more particularly to a stored energy trigger design with controlled activation distance implementation.

### BACKGROUND OF THE INVENTION

Triggers are utilized in a wide variety of mechanical structures. In many industries, such as in automotive design and manufacture, they are utilized to activate additional mechanical components. In one such application, a trigger is utilized to release an automotive seat back such that it may be folded down. These triggers commonly have two essential characteristics. The first is simple and reliable activation. The second is the ability to be mechanically reset after activation.

Often such trigger assemblies require considerable number of active components in order to ensure proper and consistent operation. Gearing and bearing usage additionally is common. The additional complexity carries with it additional warranty concerns in addition to reductions in operational life-span. In addition, often these systems utilize rigid connections between the trigger assembly and the activation components. These rigid connections require tight tolerances and may result in increased wear.

It would be highly desirable to have simple and reliable trigger assembly that would release stored energy into an activation element. In addition, it would be highly desirable to have such a simple and reliable trigger assembly that utilized semi-rigid activation assemblies such as push-wire assemblies.

### SUMMARY OF THE INVENTION

In accordance with the objects of the present invention a stored energy trigger assembly is provided including a mounting substrate and a pawl plate rotationally mounted thereto having a pawl mount end, a pawl trigger end, and a pawl lock protrusion positioned between. The pawl plate rotatable between a pawl lock position and a pawl disengage position to which it is biased. A cam plate is rotationally engaged to the mounting substrate and includes a cam plate upper surface, a earn plate lower surface, a cam lock slot, and a push wire engagement protrusion positioned on a cam plate periphery. It is rotatable between a cam lock position and a cam release position to which it is biased. A pawl trigger element engages the pawl trigger end and is configured to move the pawl plate to the pawl disengage position. A push wire assembly is moved a wire activation distance when the cam plate is moved to the cam release position. The pawl lock protrusion is positioned within the cam lock slot and restrains the cam plate until the pawl trigger element moves the pawl plate into the pawl disengage position wherein the pawl lock protrusion moves out of the cam lock slot and the cam plate is free to move into the cam release position.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of a stored energy trigger assembly in accordance with the present invention.

FIG. 2 is an exploded view of the stored energy trigger assembly as illustrated in FIG. 1.

FIG. 3 is an illustration of the stored energy trigger assembly illustrated in FIG. 1, the assembly shown in the cam lock position.

FIG. 4 is an illustration of the stored energy trigger assembly illustrated in FIG. 1, the assembly shown in the cam release position.

### DESCRIPTION OF PREFERRED EMBODIMENTS

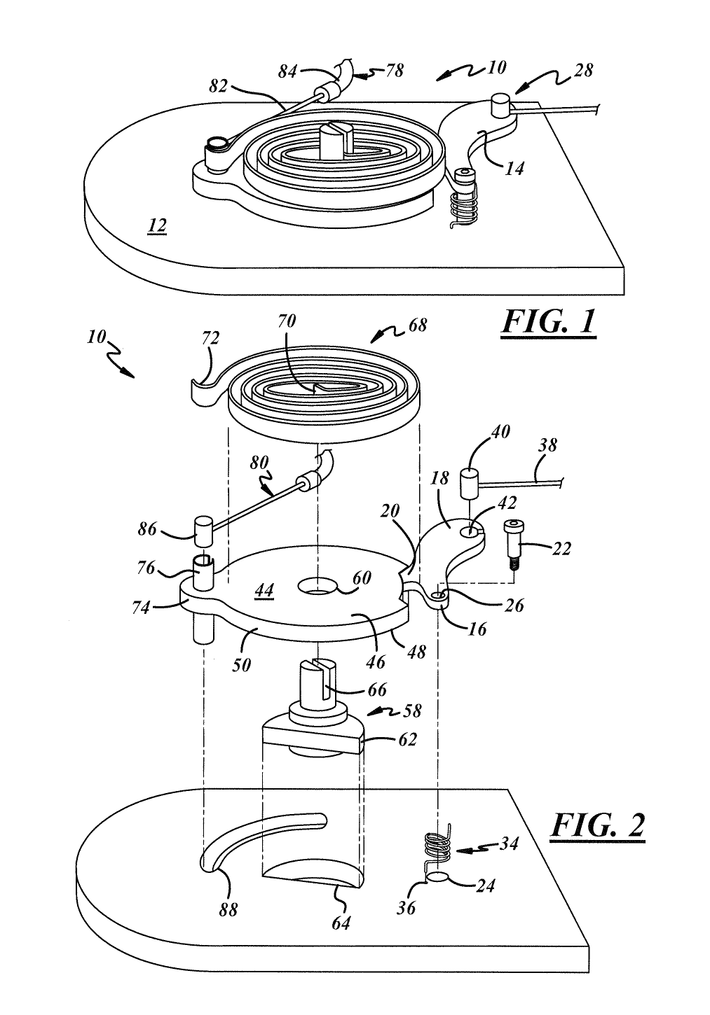

Referring now to FIG. 1, which is an illustration of a stored energy trigger assembly 10 in accordance with the present invention. Although the present invention is contemplated for use in automotive seat release assembly, it is understood that the developed technology disclosed herein may be applicable to a wide variety of additional applications as would become apparent in light of the disclosures of this specification.

The stored energy trigger assembly 10 includes a mounting substrate 12 which may be formed independently or in concert with structures in which the trigger assembly 10 is installed. A pawl plate 14 is rotatably engaged to the mounting substrate 12. Although variations of the pawl plate 14 are contemplated, in one embodiment, the paw plate 14 comprises an elongated pawl arm. The pawl plate 14 preferably includes a pawl mount end 16 and a pawl trigger end 18. A pawl lock protrusion 20 is positioned between the pawl mount end 16 and the pawl trigger end 18. Although the pawl plate 14 may rotatably engage the mounting substrate in a variety of fashions, one embodiment contemplates the use of a pawl rotational mount post 22 positioned within a pawl mount slot 24 formed in the mounting substrate 12. A pawl post slot 26 may be formed on the pawl plate 14 to house the pawl rotational mount post 22. The pawl plate 14, therein is rotatably secured to the mounting substrate 12.

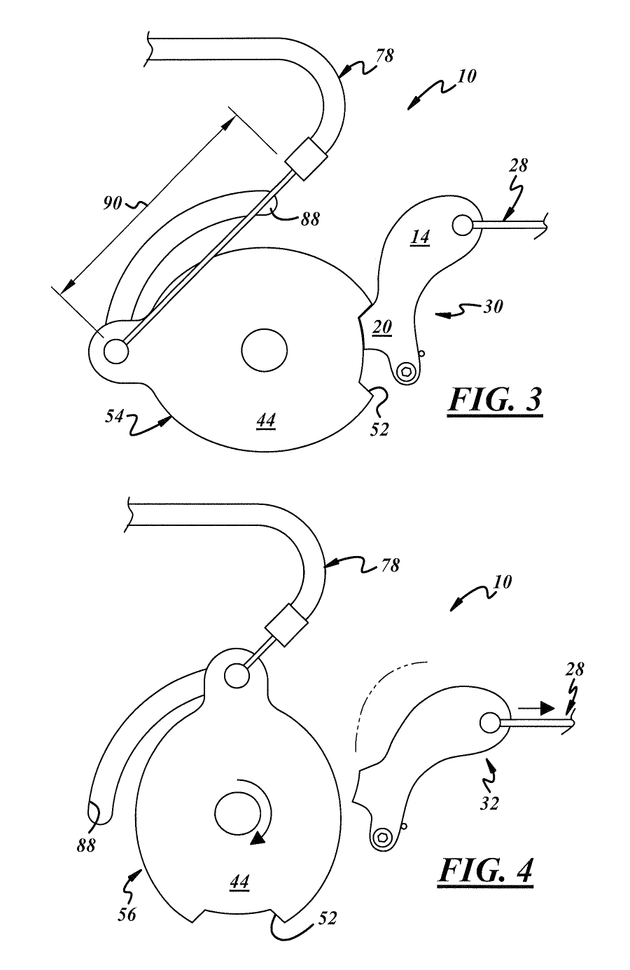

A pawl trigger element 28 is engaged to the pawl trigger end 18 and is capable of rotating the pawl plate 14 between a pawl lock position 30 (see FIG. 3) and a pawl disengage position 32 (see FIG. 4). A pawl bias spring 34 is utilized to bias the pawl plate 14 into the pawl lock position 30. In one embodiment, the pawl bias spring 34 is positioned around the pawl rotational mount post 22, is secured within a substrate spring slot 36, and engages the pawl plate 14. Although a various pawl trigger elements 28 are contemplated, one embodiment contemplates the use of a trigger cable 38 affixed to a trigger cable post 40. The trigger cable post 40 is secured within a pawl trigger post slot 42 formed within the pawl plate 14. By way of pulling on the trigger cable 38, the pawl plate 14 can be moved into the pawl disengagement position 32. Subsequently, by releasing the trigger cable 38, the biased pawl plate 14 will automatically return to the pawl lock position 30.

An additional active element in the present invention is a circular cam plate 44 also rotationally engaged to the mounting substrate 12. The cam plate 44 is comprised of a cam plate upper surface 46, a cam plate lower surface 48, and a cam plate periphery 50. A cam lock slot 52 is formed on the cam plate periphery 50 and is configured to selectively engage the pawl lock protrusion 20. The cam plate 44 is rotatable between a cam lock position 54 and a cam release position 56. The cam plate 44 is biased towards the cam release position 56. When in the cam lock position 54 and the pawl plate 14 is in the pawl lock position 30, the pawl lock protrusion 20 engages the cam lock slot 52 and restrains the cam plate 44 from movement. Upon movement of the pawl plate 14 to the pawl disengage position 32, the cam plate 44 is free to follow its bias and move into the cam release position 56.

Although rotational mounting and biasing of the cam plate 50 could have been achieved in a variety of fashions, the present invention contemplates the use of a substrate mount post 58 engaged to the mounting substrate 12. The substrate mount post 58 protrudes upwards through a cam mount center axis slot 60 to allow rotational movement of the cam plate 44. In one embodiment, the substrate mount post 58 includes a semi-circular engagement body 62 configured to securely engage a semi-circular body slot 64 formed in the mounting substrate 12. The substrate mount post 58 further includes a spring slot 66 formed therein and protruding above the cam plate upper surface 46. A coil leaf spring 68 is positioned on the cam plate upper surface 46 and includes a center coil end 70 and an outer coil end 72. The center coil end 70 is preferably configured to reside in and securely engage the spring slot 66. The coil leaf spring 68 provides the bias to the cam plate 44.

The cam plate 44 further includes a push wire (activation element) engagement protrusion 74 formed on the cam plate periphery 50. A push wire (activation element) engagement post 76 is mounted within the push wire engagement protrusion 74 and extends both below the cam plate lower surface 48 as well as above the cam plate upper surface 46. A particular novel element of the present invention comprises a push wire (activation element) assembly 78 engaging the push wire engagement post 76. Push wires 78 are commonly comprised of a push wire cable 80 made up of a main push wire 82 slidably residing within a push wire housing 84. This allows the push wire assembly 78 to not only act as an activation element, but also to allow the push wire assembly 78 to push the cam plate 44 back into the cam lock position 54 after activation. In one example, the movement of a passenger seat back into an upright position would push on the push wire assembly 78 and resent the cam plate 44. Although the push wire cable 80 may be attached to the push wire engagement post 76 in a variety of fashions, one embodiment contemplates the use of a push wire post shell 86 that covers and engages the push wire engagement post 76. The push wire engagement post 76 is additionally utilized to engage the outer coil end 72 of the coil leaf spring 68.

An additional novel concept of the present invention involves a semi-circular activation distance control slot 88 formed in the mounting substrate 12. The push wire engagement post 76 protrudes downward and slidably resides within the activation distance control slot 88. This precisely controls the amount of rotation of the cam plate 44 and thereby provides precise control of the push wire (activation element) activation distance 90 (see FIG. 3). The axial translation provides a smooth and precise activation distance 90 to the push wire assembly 78. This, in turn, allows the present invention to be utilized in a greater variety of applications.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A stored energy trigger assembly comprising:
a mounting substrate;
a pawl plate rotationally mounted to said mounting substrate, said pawl plate including a pawl mount end, a pawl trigger end, and a pawl lock protrusion positioned between said pawl mount end and said pawl trigger end, said pawl plate rotatable between a pawl lock position and a pawl disengage position, said pawl plate biased towards said pawl disengage position;
a cam plate rotationally engaged to said mounting substrate, said cam plate including a cam plate upper surface, a cam plate lower surface, a cam lock slot, and a push wire engagement protrusion positioned on a cam plate periphery, said cam plate rotatable between a cam lock position and a cam release position, said cam plate biased towards said cam release position;
a pawl trigger element engaging said pawl trigger end, said pawl trigger element configured to move said pawl plate from said pawl lock position to said pawl disengage position;
a push wire assembly engaging said push wire engagement position, said push wire assembly moved a wire activation distance when said cam plate is moved from said cam lock position to said cam release position;
wherein said pawl lock protrusion is positioned within said cam lock slot and restrains said cam plate in said cam lock position, wherein upon said pawl trigger element moves said pawl plate into said pawl disengage position said pawl lock protrusion moves out of said cam lock slot and said cam plate is free to move into said cam release position.

2. A stored energy trigger assembly as described in claim 1, further comprising:
a push wire engagement post mounted to said push wire engagement position, said push wire engagement post protruding through said cam plate lower surface;
an activation distance control slot formed in said mounting substrate, said push wire engagement post positioned within said activation distance control slot, said activation distance control slot limiting said wire activation distance.

3. A stored energy trigger assembly as described in claim 1, further comprising:
a pawl rotational mount post engaged to said pawl mount end, said pawl rotational mount post configured to rotationally reside within a pawl mount slot formed in said mounting substrate;
a pawl bias spring positioned around said pawl rotational mount post, said pawl bias spring biasing said pawl plate to said pawl disengage position.

4. A stored energy trigger assembly as described in claim 1, further comprising:
a substrate mount post positioned on said mounting substrate, said substrate mount post protruding upwards through a cam mount center axis slot formed in said cam plate;
a coil leaf spring including a center coil end and an outer coil end, said center coil end affixed to said substrate mount post, said outer coil end engaging a push wire engagement post mounted to said cam plate, said coil leaf spring biasing said cam plate towards said cam release position.

5. A stored energy trigger assembly as described in claim 4, wherein said substrate mount post comprises:
an engagement body configured to securely engage a body slot formed in said mounting substrate; and
a spring slot configured to engage said center coil end.

6. A stored energy trigger assembly as described in claim 2, wherein said activation distance control slot comprises a semi-circular activation distance control slot.

7. A stored energy trigger assembly as described in claim 5, wherein said engagement body comprises a semi-circular engagement body and said body slot comprises a semi-circular body slot, said engagement body removably engaging said body slot.

8. A stored energy trigger assembly as described in claim 1, wherein said pawl trigger element comprises:
a trigger cable affixed to a trigger cable post, said trigger cable post positioned within a pawl trigger post slot formed in said pawl trigger end.

9. A stored energy trigger assembly as described in claim 1, wherein:
said push wire engagement post extends above said cam plate upper surface; and
said push wire assembly includes a push wire cable affixed to a push wire post shell, said push wire post shell engaging said push wire engagement post.

10. A stored energy trigger assembly comprising:
a mounting substrate;
a pawl plate rotationally mounted to said mounting substrate, said pawl plate including a pawl mount end, a pawl trigger end, and a pawl lock protrusion positioned between said pawl mount end and said pawl trigger end, said pawl plate rotatable between a pawl lock position and a pawl disengage position, said pawl plate biased towards said pawl disengage position;
cam plate rotationally engaged to said mounting substrate, said cam plate including a cam plate upper surface, a cam plate lower surface, a cam lock slot, and an activation element protrusion positioned on a cam plate periphery, said cam plate rotatable between a cam lock position and a cam release position, said cam plate biased towards said cam release position;
a pawl trigger element engaging said pawl trigger end, said pawl trigger element configured to move said pawl plate from said pawl lock position to said pawl disengage position;
an activation element assembly engaging said an activation element engagement position, said an activation element assembly moved a an activation element activation distance when said cam plate is moved from said cam lock position to said cam release position;
an activation element engagement post mounted to said activation element engagement position, said activation element engagement post protruding through said cam plate lower surface;
an activation distance control slot formed in said mounting substrate, said activation element engagement post positioned within said activation distance control slot, said activation distance control slot limiting said an activation element activation distance
wherein said pawl lock protrusion is positioned within said cam lock slot and restrains said cam plate in said cam lock position, wherein upon said pawl trigger element moves said pawl plate into said pawl disengage position said pawl lock protrusion moves out of said cam lock slot and said cam plate is free to move into said cam release position.

11. A stored energy trigger assembly as described in claim 10, wherein said activation element assembly comprises:
a push wire assembly including a main push wire element positioned within a push wire housing.

12. A stored energy trigger assembly as described in claim 10, further comprising:
a activation element engagement post mounted to said activation element engagement position, said activation element engagement post protruding through said cam plate lower surface;
an activation distance control slot formed in said mounting substrate, said activation element engagement post positioned within said activation distance control slot, said activation distance control slot limiting said activation element activation distance.

13. A stored energy trigger assembly as described in claim 10, further comprising:
a substrate mount post positioned on said mounting substrate, said substrate mount post protruding upwards through a cam mount center axis slot formed in said cam plate;
a coil leaf spring including a center coil end and an outer coil end, said center coil end affixed to said substrate mount post, said outer coil end engaging an activation element engagement post mounted to said cam plate, said coil leaf spring biasing said cam plate towards said cam release position.

14. A stored energy trigger assembly as described in claim 13, wherein said substrate mount post comprises:
an engagement body configured to securely engage a body slot formed in said mounting substrate; and
a spring slot configured to engage said center coil end.

15. A stored energy trigger assembly as described in claim 10, wherein said activation distance control slot comprises a semi-circular activation distance control slot.

16. A stored energy trigger assembly as described in claim 14, wherein said engagement body comprises a semi-circular engagement body and said body slot comprises a semi-circular body slot, said engagement body removably engaging said body slot.

17. A stored energy trigger assembly as described in claim 10, wherein said pawl trigger element comprises:
a trigger cable affixed to a trigger cable post, said trigger cable post positioned within a pawl trigger post slot formed in said pawl trigger end.

18. A method of triggering an activation element assembly comprising:
activating a pawl trigger element engaged to a pawl trigger end of a pawl plate, said pawl trigger element configured to move said pawl plate from a pawl lock position to a pawl disengage position, said pawl plate rotationally mounted to a mounting substrate, said pawl plate including a pawl mount end and a pawl lock protrusion positioned between said pawl mount end and said pawl trigger end, said pawl plate rotatable between said pawl lock position and said pawl disengage position, said pawl plate biased towards said pawl disengage position;
said pawl plate selectively engaging a cam plate rotationally engaged to said mounting substrate, said cam plate including a cam plate upper surface, a cam plate lower surface, a cam lock slot, and an activation element engagement protrusion positioned on a cam plate periphery, said cam plate rotatable between a cam lock position and a cam release position, said cam plate biased towards said cam release position;
engaging said an activation element engagement position with an activation element assembly, said an activation element assembly moved a an activation element activation distance when said cam plate is moved from said cam lock position to said cam release position;
controlling said activation element assembly using an activation element engagement post mounted to said activation element engagement position, said activation element engagement post protruding through said cam plate lower surface to engage an activation distance control slot formed in said mounting substrate, said activation element engagement post positioned within said activation distance control slot, said activation distance control slot limiting said an activation element activation distance
wherein said pawl lock protrusion is positioned within said cam lock slot and restrains said cam plate in said cam lock position, wherein upon said pawl trigger element moves said pawl plate into said pawl disengage position said pawl lock protrusion moves out of said cam lock slot and said cam plate is free to move into said cam release position.

19. A method as described in claim 18, wherein said activation element assembly comprises:
a push wire assembly including a main push wire element positioned within a push wire housing.

20. A method as described in claim 18, wherein said pawl trigger element comprises:
a trigger cable affixed to a trigger cable post, said trigger cable post positioned within a pawl trigger post slot formed in said pawl trigger end.
